(19) United States
(12) Patent Application Publication
(10) Pub. No.: US 2009/0311366 A1
(43) Pub. Date: Dec. 17, 2009

(54) DRY FOOD TO REDUCE DOGS' APPETITES

(76) Inventors: Vincent Biourge, Villevielle (FR); Jérôme Gays, Montpellier (FR); Thomas Bissot, Montpellier (FR); Claude Ecochard, Aigues-Vives (FR); Renaud Sergheraert, Fabregues (FR); Mickael Weber, Lunel (FR); Yannick Soulard, Lattes (FR)

Correspondence Address: IP GROUP OF DLA PIPER LLP (US), ONE LIBERTY PLACE, 1650 MARKET ST, SUITE 4900, PHILADELPHIA, PA, 19103, US

(21) Appl. No.: 12/374,542

(22) PCT Filed: Jul. 20, 2007
(86) PCT No.: PCT/EP07/57501

§ 371 Date: Mar. 4, 2009

(30) Foreign Application Priority Data
Jul. 21, 2006 (FR) 06/06681

(51) Int. Cl. A23K 1/18; A23K 1/14

(52) U.S. Cl. 426/2; 426/630

(57) ABSTRACT

A dry food for dogs that reduces the appetite of dogs including psyllium seeds or parts of sees at a concentration of 0.2% to 4%, based on the weight of the foodstuff.

### RELATED APPLICATION

This is a §371 of International Application No. PCT/EP2007/057501, with an international filing date of Jul. 20, 2007 (WO 2008/009739 A1, published Jan. 24, 2008), which is based on French Patent Application No. 06/06681, filed Jul. 21, 2006.

### BACKGROUND

The pet-food industry produces two main categories of food: wet food and dry food.

Wet food usually has a moisture level of over 70% water while dry food rarely contains more than 12%. Wet food is distributed in the form of cans whereas dry food is in the form of granules, biscuits and, most commonly, extrudated nuggets.

Wet food primarily consists of meat, abattoir by-products and/or fish. Dry foods consist of cereals, various by-products of the food industry (flour, starch, sugar and oil producing industries), dried meat or fish meal, minerals (calcium carbonate, calcium phosphates, mineral trace elements), vitamins and flavorings.

This is why wet food has been traditionally regarded as more appetizing than dry food.

Nonetheless, the pet-food industry has succeeded in overcoming this disadvantage by making dry food more and more palatable through the choice of ingredients used, the technology for manufacturing nuggets and, most importantly, the use of new flavorings which dogs like and which stimulate their appetites.

The unexpected consequence of this success is that 20 to 25% of dogs are obese in the industrialized countries. Overeating gives dogs excess metabolizable energy which accumulates mainly in the form of fat.

Obesity leads to many pathological disorders in these animals, the most common of which are arthritic disease, diabetes and cardiovascular disease.

Many methods have been put forward to reduce overeating in dogs, for example:
rationing the amount of food: the daily amount of food given to the animal is reduced drastically but hunger makes them nervous and can lead to unpleasant and possibly even aggressive behavior;
formulation of low-calorie products, especially by reducing the amount of fat. However, a severe cut in fat quantities can cause pathological skin or cardiovascular disorders as a result of a deficiency in essential fatty acid, especially the omega-3 fatty acids;
formulation of low-calorie products with a higher protein content to increase the protein/calorie ratio. However, this type of formula has little effect on the spontaneous consumption of food by dogs and obliges the owner to apply strict rationing which is often difficult to impose and has the same disadvantages as the quantity rationing approach described above.

The problems caused by these current methods of controlling the energy intake of dogs are aggravated when animals are bred in a confined environment, such as a town apartment.

Moreover, it is know that the sensation of hunger in dogs gives rise to complex physiological mechanisms bringing into play many physico-chemical and intermediate chemico-biological receptors:
oro-pharyngeal, gustative and olfactory receptors;
physical receptors of the stomach and intestine;
chemosensitive receptors of the intestine;
   porto-hepatic chemoreceptors sensitive to glycaemia or pyruvate concentration in the portal vein;
   gastro-intestinal hormones including cholecystokinine; pancreas hormones, glucagon and insulin.

### SUMMARY

We provide a method of reducing appetite in dogs including administering to a dog a dry foodstuff including psyllium seeds or parts of seeds at a concentration of 0.2% to 4%, based on the weight of the foodstuff.

We also provide a dry food for dogs that reduces the appetite of dogs including psyllium seeds or parts of seeds at a concentration of 0.2% to 4%, based on the weight of the foodstuff.

### DETAILED DESCRIPTION

We unexpectedly discovered that psyllium can reduce the appetite of dogs and their spontaneous consumption of food.

We thus use psyllium seeds or parts of seeds incorporated into dry food for dogs to reduce the appetite of dogs, at a concentration of over 0.2%, preferably over 0.5% and below 4% by weight of the foodstuff.

Psyllium is a small seed produced by plants of the genus Plantago, principally Plantago ovata and Plantago afra. Psyllium seeds are very rich in soluble and insoluble fibers (65% cellulose, hemicellulose and lignin, on the one hand, and 35% of gums, pectins and mucilage on the other). These fibers are found mainly in the tegument or seed (husk).

We found that the effect of psyllium on dogs' appetites can be obtained with the whole psyllium seed and more advantageously, with its tegument (husk). Seeds and teguments can therefore be combined in a mixture.

Experiments have shown that even relatively small amounts of psyllium seeds or parts of seeds are enough to produce the above-described effect.

Therefore the quantity by weight of psyllium or parts of psyllium seeds should be greater than 0.2% by weight of the food, preferably greater than 0.3% by weight and even more preferably greater than 0.5%.

Levels below 4% can be used effectively.

It is also possible to use mixtures of psyllium seeds and teguments (husks).

We also provide dry food for dogs aimed at reducing their appetites containing psyllium seeds or parts of seeds at a concentration greater than 0.2% by weight, preferably greater than 0.5% and below 4% by weight, these dry foods for dogs containing preferably at least one cereal, at least one animal or vegetable protein source and at least one animal or vegetable fat source.

Psyllium seeds or parts of seeds can be added to known dry food compositions for dogs. Given the relatively small quantity needed to produce a reduction in appetite, it is not necessary to significantly modify the compositions in question which can be obtained using any conventional process used in the art.

Without knowing the exact mechanism of this effect and without being bound by any particular theory, we carried out the following non-exhaustive experiments to demonstrate the ability of psyllium to reduce spontaneous food consumption in dogs.

### Experiment 1

We formulated and manufactured by extrusion two nugget foods consisting of cereals, poultry meal, maize gluten, dried beetroot pulp, poultry fat, fish oil, calcium carbonate, flavoring for dogs and a premix of vitamins and mineral trace elements.

The two foods were formulated to contain:
Moisture: maximum 9.5%.
Metabolizable energy: minimum 2 900 kcal/kg.
Proteins: minimum 30%.
Fats: minimum 7.5%.
Crude fiber: minimum 17.5%.

Ashes: maximum 5.8%.
Non-nitrogenated extract: q.s. [100−(moisture+protein+fats+crude fiber+ashes)]%.

The first food formulated was used as the control. The second food, designated as <<Psyllium>>, contained 0.5% psyllium tegument (husk).

For the purposes of the experiment, we also tested a third commercial pet food, Hill's Canine r/d, currently used to control obesity in dogs.

These three foods were tested on three groups of 6 dogs, each group including 2 Shetland sheepdogs (average weight: 8.5 kg), 2 Breton Spaniels (average weight: 20 kg) and 2 Labradors (average weight: 43 kg).

Each animal was fed with its corresponding test food ad libitum every day for a limited period of 15 minutes. At the end of the meal, the amount of food consumed by each animal was carefully weighed. The experiment was repeated for 10 days.

Average food consumption over a 10-day period was as follows (in grams/dog/day):
Control: 216.2 c
Psyllium: 172.3 a
Hill's Canine r/d: 201.7 b
(a, b, c: significant difference at p<0.05).

The presence of psyllium therefore considerably reduced spontaneous consumption in dogs: by 20.3% with respect to the control and by 14.6% with respect to the reference commercial product.

To eliminate differences in consumption related to the large differences in dog size, the results were adjusted to the metabolic weight of each animal (in grams/kg weight^{0.73}):
Control: 18.4 b
Psyllium: 15.2 a
Hill's Canine r/d: 21.0 c
(a, b, c: significant difference at p<0.05).

In terms of metabolic weight, spontaneous consumption in dogs was considerably reduced by psyllium: by 17.4% with respect to the control and by 27.6% with respect to the reference commercial product.

### Experiment 2

We formulated and manufactured by extrusion two nugget foods consisting of cereals, poultry meal, maize gluten, dried beetroot pulp, poultry fat, fish oil, soya oil, calcium carbonate, flavoring for dogs and a premix of vitamins and mineral trace elements.

The two foods were formulated to contain:
Moisture: maximum 9.5%.
Metabolizable energy: minimum 3 450 kcal/kg.
Proteins: minimum 28%.
Fats: minimum 9%.
Crude fiber: minimum 7.9%.
Ashes: maximum 4.7%.
Non-nitrogenated extract: q.s. [100−(moisture+protein+fats+crude fiber+ashes)]%.

The first food formulated in this way was used as the control. The second food, designated as <<Psyllium>>, contained 0.5% psyllium tegument (husk). These two foods were tested on three groups of 6 dogs, each group including 2 Labradors (average weight: 33.5 kg), 2 German Shepherds (average weight: 29.5 kg) and 2 Boxers (average weight: 30.5 kg).

The two foods were distributed as follows: each animal was fed ad libitum for 15 minutes at 08, 09, 10 and 11 o'clock.

Average food consumption was as follows (in grams/kg weight^{0.73}):

| | Control | Psyllium |
|---|---|---|
| 08 o'clock | 36.1 b | 31.1 a |
| 09 o'clock | 5.6 a | 3.5 a |
| 10 o'clock | 8.0 a | 7.2 a |
| 11 o'clock | 4.6 a | 5.1 a |
| In total | 54.3 b | 46.8 a |

(on the same a, b line: significant difference at p ≦ 0.05).

The reduction in food consumption in the presence of psyllium is significant at the first hour and at 3 hours. The presence of psyllium therefore greatly reduces spontaneous consumption by dogs, by 13.8% compared to the control.

### Experiment 3

We carried out the following experiment to establish whether these differences in consumption were due to the lack of palatability of psyllium:
105 dogs of various breeds and very different sizes were fed ad libitum simultaneously with two bowls, one containing <<Psyllium>> food and the other containing Hill's Canine r/d as sued in Experiment 1. After 60 minutes, the bowls were removed and the food consumed weighed.
Average consumption expressed as a percentage of the total amount of the two foods consumed by each animal is as follows:
   Psyllium: 82 a
   Hill's Canine r/d: 18 b
   (a, b: significant difference at p<0.05).

This experiment shows that psyllium in no way diminishes appetite for the food containing it.

### Experiment 4

We carried out the following experiment to establish whether these differences in consumption were due to the lack of palatability of psyllium:
27 dogs of various breeds and very different sizes were fed ad libitum simultaneously with two bowls, one containing <<Psyllium>> food and the other containing the Control Food of Experiment 1. After 60 minutes, the bowls were removed and the food consumed weighed.
Average consumption expressed as a percentage of the total amount of the two foods consumed by each animal is as follows:
   Psyllium: 81 a
   Control: 19 b
   (a, b: significant difference at p<0.05).

This experiment shows that psyllium in no way diminishes appetite for the food containing it.

This set of four experiments shows that the presence of psyllium significantly reduces spontaneous consumption of food and that this reduction in consumption is not because psyllium is unappetizing.

### Experiment 5

The three food types used in Experiment 1 were again given to the dogs used in the first experiment. However, the daily food ration was modified as follows: each animal was fed ad libitum for 15 minutes, at 8, 9, 10 and 11 o'clock in the morning.

Average consumption of each food was as follows (in grams/kilo weight^{0.73}):

| | Control | Psyllium | Hill's Canine r/d |
|---|---|---|---|
| 08 o'clock | 19.4 b | 14.1 a | 16.4 ab |
| 09 o'clock | 11.5 b | 5.3 a | 10.3 b |
| 10 o'clock | 9.2 b | 1.7 a | 7.0 b |
| 11 o'clock | 4.5 b | 0.6 a | 3.7 b |

(on the same a, b line: significant difference at p ≦ 0.05).

This effect of psyllium in decreasing food consumption lasts for at least 3 hours.

### Experiment 6

Experiment 5 was repeated but with food only given twice a day, at 8 o'clock in the morning and 3 o'clock in the afternoon.

Average consumption of each food was as follows (in grams/kilo weights^{0.73}):

| | Control | Psyllium | Hill's Canine r/d |
|---|---|---|---|
| 08 o'clock | 21.8 b | 15.6 a | 19.8 b |
| 15 o'clock | 22.3 b | 16.0 a | 19.2 b |

(on the same a, b line: significant difference at p ≦ 0.05).

This effects of psyllium in decreasing food consumption lasts for at least 7 hours.

This set of experiments shows that the presence of psyllium in food significantly reduces spontaneous consumption by dogs and that this decrease is not due to the lack of palatability of psyllium.

1. A method of reducing appetite in dogs comprising administering to a dog a dry foodstuff comprising psyllium seeds or parts of seeds at a concentration of 0.2%, to 4%, based on the weight of the foodstuff.

2. The method according to claim 1, wherein psyllium is provided in the form of a mixture of seeds and teguments (husks).

3. The method according to claim 1, wherein a part of the psyllium is tegument (psyllium husk) which is incorporated into the foodstuff at a concentration of 0.3% to 4% by weight, based on the weight of the foodstuff.

4. A dry food for dogs that reduces the appetite of dogs comprising psyllium seeds or parts of seeds at a concentration of 0.2% to 4%, based on the weight of the foodstuff.

5. The dry food according to claim 4, further comprising at least one cereal, at least one animal or vegetable protein source and at least one animal or vegetable fat source.

6. The dry food according to claim 4, wherein the concentration is 0.5% to 4%.
